(19) United States
(12) Patent Application Publication
(10) Pub. No.: US 2026/0004803 A1
(43) Pub. Date: Jan. 1, 2026

(54) MAGNETIC HEAD AND MAGNETIC RECORDING DEVICE

(71) Applicant: KABUSHIKI KAISHA TOSHIBA, Tokyo (JP)

(72) Inventors: Yuji NAKAGAWA, Kawasaki Kanagawa (JP); Satoshi SHIROTORI, Yokohama Kanagawa (JP); Yoshihiro HIGASHI, Komatsu Ishikawa (JP); Akira KIKITSU, Yokohama Kanagawa (JP)

(73) Assignee: KABUSHIKI KAISHA TOSHIBA, Tokyo (JP)

(21) Appl. No.: 19/239,246

(22) Filed: Jun. 16, 2025

(30) Foreign Application Priority Data
Jul. 1, 2024 (JP) 2024-106415

(51) Int. Cl. G11B 5/11

(52) U.S. Cl. CPC G11B 5/11

(57) ABSTRACT

According to one embodiment, a magnetic head includes reproducing section including a first reproducing element. The first reproducing element including first to fourth shields, a first magnetic member, and first and second conductive members. The first magnetic member is provided between the first shield and the second shield, and between the third shield and the fourth shield. The first shield includes a first end corresponding to a medium facing face. The second shield includes a second end corresponding to the medium facing face. A first distance between the first end and the first conductive member in a third direction crossing a plane including the first direction and the second direction is longer than a second distance between the second end and the second conductive member in the third direction.

### CROSS-REFERENCE TO RELATED APPLICATIONS

This application is based upon and claims the benefit of priority from Japanese Patent Application No. 2024-106415, filed on Jul. 1, 2024; the entire contents of which are incorporated herein by reference.

### FIELD

Embodiments described herein relate generally to a magnetic head and a magnetic recording device.

### BACKGROUND

A magnetic head including a magnetic sensor using a magnetic layer is used to record information on a magnetic recording medium such as an HDD (Hard Disk Drive). Improved characteristics of the magnetic head are desired.

### BRIEF DESCRIPTION OF THE DRAWINGS

FIGS. 1A and 1B are schematic view illustrating a magnetic head according to a first embodiment;

FIG. 2 is a schematic cross-sectional view illustrating the magnetic head according to the first embodiment;

FIGS. 3A and 3B are schematic views illustrating a magnetic head according to a second embodiment;

FIG. 4 is a schematic cross-sectional view illustrating a magnetic head according to the second embodiment;

FIG. 5 is a schematic cross-sectional view illustrating a magnetic head according to the second embodiment;

FIG. 6 is a schematic cross-sectional view illustrating a magnetic head according to the second embodiment;

FIG. 7 is a schematic cross-sectional view illustrating a magnetic head according to the second embodiment;

FIGS. 8A and 8B are schematic views illustrating a magnetic head according to the second embodiment;

FIG. 9 is a schematic cross-sectional view illustrating a magnetic head according to the second embodiment;

FIGS. 10A and 10B are schematic views illustrating a magnetic head according to a third embodiment;

FIGS. 11A and 11B are graphs illustrating the characteristics of a magnetic head;

FIG. 12 is a schematic perspective view illustrating the magnetic head and the magnetic recording device according to the embodiment;

FIG. 13 is a schematic perspective view illustrating a part of the magnetic recording device according to the embodiment;

FIG. 14 is a schematic perspective view illustrating the magnetic recording device according to the embodiment; and

FIGS. 15A and 15B are schematic perspective views illustrating a part of the magnetic recording device according to the embodiment.

### DETAILED DESCRIPTION

According to one embodiment, a magnetic head includes reproducing section including a first reproducing element. The first reproducing element including a first shield, a second shield, a third shield, a fourth shield, a first magnetic member, a first conductive member, and a second conductive member. A second direction from the third shield to the fourth shield crosses a first direction from the first shield to the second shield. The first magnetic member is provided between the first shield and the second shield, and between the third shield and the fourth shield. The first conductive member is provided between the first shield and the first magnetic member. The first conductive member is non-magnetic. The second conductive member is provided between the first magnetic member and the second shield. The second conductive member is non-magnetic. The first shield includes a first end corresponding to a medium facing face. The second shield includes a second end corresponding to the medium facing face. A first distance between the first end and the first conductive member in a third direction crossing a plane including the first direction and the second direction is longer than a second distance between the second end and the second conductive member in the third direction.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

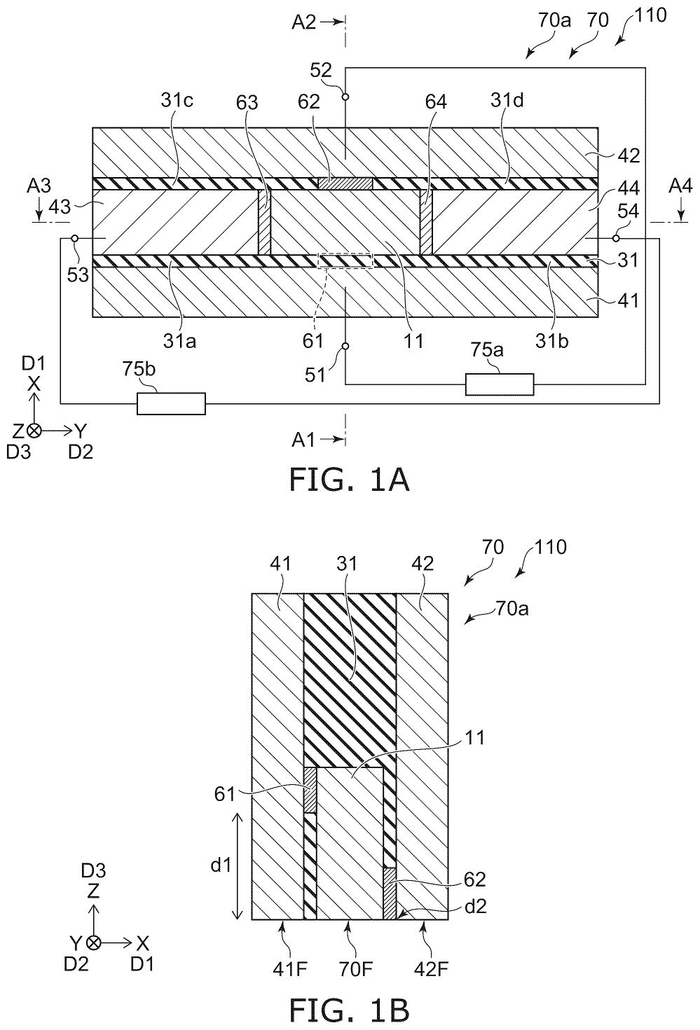

FIGS. 1A and 1B are schematic view illustrating a magnetic head according to a first embodiment.

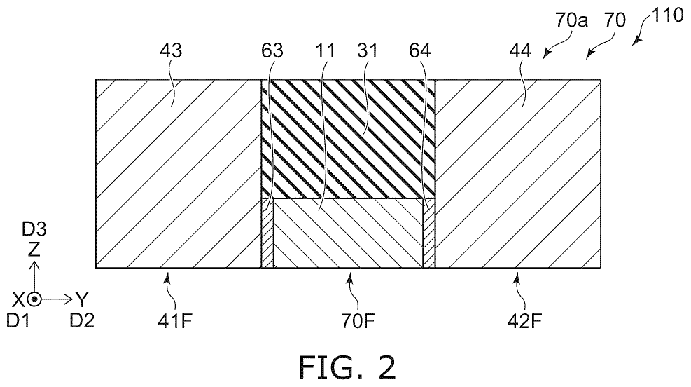

FIG. 2 is a schematic cross-sectional view illustrating the magnetic head according to the first embodiment.

FIG. 1A is a plan view. FIG. 1B is a cross-sectional view along the line A1-A2 in FIG. 1A. FIG. 2 is a cross-sectional view along the line A3-A4 in FIG. 1A.

As shown in FIG. 1, a magnetic head 110 according to the embodiment includes a reproducing section 70. The reproducing section 70 includes a first reproducing element 70a. The first reproducing element 70a includes a first shield 41, a second shield 42, a third shield 43, a fourth shield 44, a first magnetic member 11, a first conductive member 61, and a second conductive member 62.

A second direction D2 from the third shield 43 to the fourth shield 44 crosses a first direction D1 from the first shield 41 to the second shield 42.

In this example, the first direction D1 is defined as an X-axis direction. One direction perpendicular to the X-axis direction is defined as a Y-axis direction. A direction perpendicular to the X-axis and Y-axis directions is defined as a Z-axis direction. The second direction D2 is, for example, the Y-axis direction.

The X-axis direction corresponds, for example, to a down-track direction. The Y-axis direction corresponds, for example, to a cross-track direction. The Z-axis direction corresponds, for example, to a height direction.

The first magnetic member 11 is provided between the first shield 41 and the second shield 42, and between the third shield 43 and the fourth shield 44. The first conductive member 61 is provided between the first shield 41 and the first magnetic member 11. The first conductive member 61 is non-magnetic. The second conductive member 62 is provided between the first magnetic member 11 and the second shield 42. The second conductive member 62 is non-magnetic.

As shown in FIG. 1B, the first reproducing element 70a includes a medium facing face 70F. The medium facing face 70F faces a magnetic recording medium from which information is reproduced by the magnetic head 110. FIG. 1A corresponds to a plan view of the first reproducing element 70a looking at the medium facing face 70F.

As shown in FIG. 1B, the first shield 41 includes a first end 41F corresponding to the medium facing face 70F. The second shield 42 includes a second end 42F corresponding to the medium facing face 70F.

As shown in FIG. 1B, a first distance d1 between the first end 41F and the first conductive member 61 in a third direction D3 is longer than a second distance d2 between the second end 42F and the second conductive member 62 in the third direction D3. The third direction D3 crosses a plane including the first direction D1 and the second direction D2. The third direction D3 is, for example, the Z-axis direction. The second distance d2 may be zero. A position of the second conductive member 62 in the height direction is different from a position of the first conductive member 61 in the height direction.

As shown in FIG. 1A, in one example, the first reproducing element 70a includes a first terminal 51, a second terminal 52, a third terminal 53, and a fourth terminal 54. The first terminal 51 is electrically connected to the first shield 41. The second terminal 52 is electrically connected to the second shield 42. The third terminal 53 is electrically connected to the third shield 43. The fourth terminal 54 is electrically connected to the fourth shield 44.

For example, a first circuit 75a and a second circuit 75b may be provided. The first circuit 75a is electrically connected to the first terminal 51 and the second terminal 52. The second circuit 75b is electrically connected to the third terminal 53 and the fourth terminal 54. In one example, the second circuit 75b supplies a current between the third terminal 53 and the fourth terminal 54. The current passes through the third shield 43, the first magnetic member 11, and the fourth shield 44. At this time, for example, a voltage between the first terminal 51 and the second terminal 52 changes depending on the magnetic field to be detected. The change in voltage is thought to be caused by, for example, the anomalous Hall effect.

The change in voltage is detected by the first circuit 75a. Thereby, the magnetic field to be detected is detected. Thus, when a current flows between the third terminal 53 and the fourth terminal 54, the voltage between the first terminal 51 and the second terminal 52 can change according to the magnetic field to be detected. The magnetic field to be detected is based on, for example, information recorded on a magnetic recording medium.

In the embodiment, the first circuit 75a and the second circuit 75b may be considered to be included in the magnetic head 110 for convenience. The first circuit 75a and the second circuit 75b may be provided separately from the magnetic head 110. These circuits may be included in the magnetic recording device. The first circuit 75a includes, for example, a voltmeter. The second circuit 75b includes, for example, a current source.

As described above, in the embodiment, the position of the second conductive member 62 in the height direction is different from the position of the first conductive member 61 in the height direction. The first distance d1 between the first end 41F and the first conductive member 61 in the third direction D3 is longer than the second distance d2 between the second end 42F and the second conductive member 62 in the third direction D3. With this configuration, the direction connecting the first conductive member 61 and the second conductive member 62 is inclined with respect to the X-Y plane.

For example, the voltage generated between the first conductive member 61 and the second conductive member 62 corresponds to a component in a direction crossing (for example, a tilted direction) the third direction D3 of the magnetization in the first magnetic member 11. For example, the voltage generated between the first conductive member 61 and the second conductive member 62 corresponds to the sum of a component along the third direction D3 of the magnetization in the first magnetic member 11 and a component along the first direction D1.

For example, the magnetic recording medium may be a perpendicular magnetic recording medium. The magnetic recording medium includes a first recording region and a second recording region. These recording regions are next to each other in the down-track direction (e.g., the first direction D1). When the magnetization direction of the first recording region and the magnetization direction of the second recording region are different from each other, the magnetic fields emitted from these recording regions include a component inclined with respect to the third direction D3. The magnetic fields emitted from these recording regions include, for example, a component along the first direction D1. The component inclined with respect to the third direction D3 changes significantly at the boundary between the first recording region and the second recording region.

In the embodiment, the direction connecting the first conductive member 61 and the second conductive member 62 is inclined with respect to the X-Y plane. As a result, the signal obtained from these conductive members changes with higher sensitivity according to the inclined components of the magnetic fields emitted from the two recording regions of the magnetic recording medium. In the embodiment, high sensitivity detection is possible. Thereby, higher recording density can be obtained. According to the embodiment, it is possible to provide a magnetic head with improved characteristics.

For example, when magnetization is reversed in the first recording region and the second recording region, the magnetization near the boundary between them includes a tilted component. The signal obtained from the first conductive member 61 and the second conductive member 62 changes with higher sensitivity according to the tilted component that accompanies the magnetization reversal. Thus, high sensitivity detection can be obtained. High recording density can be obtained.

In the embodiment, a current may be supplied between the first terminal 51 and the second terminal 52, and the voltage between the third terminal 53 and the fourth terminal 54 may change according to the magnetic field to be detected. In this case as well, the signal obtained from the two conductive members changes with higher sensitivity according to the gradient components of the magnetic field emitted from the two recording regions of the magnetic recording medium. High sensitivity detection is possible. Higher recording density can be obtained.

Thus, the first reproducing element 70a may be configured to satisfy a first condition or a second condition. In the first condition, when a current flows between the third terminal 53 and the fourth terminal 54, a voltage between the first terminal 51 and the second terminal 52 changes in response to the magnetic field to be detected. In the second condition, when a current flows between the first terminal 51 and the second terminal 52, a voltage between the third terminal 53 and the fourth terminal 54 changes in response to the magnetic field to be detected.

As shown in FIG. 1B, in this example, the second conductive member 62 does not overlap the first conductive member 61 in the first direction D1. Thereby, it becomes possible to more effectively detect the inclined component of the magnetic field emanating from the magnetic recording medium.

As described above, the first magnetic member 11 has, for example, the anomalous Hall effect. For example, the first magnetic member 11 may include at least one selected from the group consisting of Co₂MnGa, Co₂MnAl, FePt, MnGa, Mn₃Sn, Mn₃Ge, Mn₃Ga, RuO₂, MnTe, CrSb, and Mn₅Si₃. With these materials, for example, the anomalous Hall effect can be effectively obtained. The first magnetic member 11 may include a Weyl ferromagnet. The first magnetic member 11 may include an L1₀ ordered alloy. The first magnetic member 11 may include a Weyl antiferromagnet. The first magnetic member 11 may include an altermagnet.

As shown in FIG. 1A, the first reproducing element 70a may further include a third conductive member 63 and a fourth conductive member 64. The third conductive member 63 is provided between the third shield 43 and the first magnetic member 11 and is non-magnetic. The fourth conductive member 64 is provided between the first magnetic member 11 and the fourth shield 44 and is non-magnetic.

In one example, at least one of the first conductive member 61, the second conductive member 62, the third conductive member 63, or the fourth conductive member 64 may include at least one selected from the group consisting of Cu, Au, Ag, Pt, Al, Pd, Ta, Ru, Hf, W, Mo, Ir, Cr, Tb, and Rh. These materials can, for example, suppress the effect of spin between the shield and the first magnetic member 11. High sensitivity is easily obtained.

The first conductive member 61 may be in contact with the first magnetic member 11. The second conductive member 62 may be in contact with the first magnetic member 11. The first conductive member 61 may be in contact with the first shield 41. The second conductive member 62 may be in contact with the second shield 42.

As shown in FIG. 1A, in this example, in the first direction D1, the third shield 43 is between a part of the first shield 41 and a part of the second shield 42. In the first direction D1, the fourth shield 44 is between another part of the first shield 41 and another part of the second shield 42.

The first shield 41 is, for example, a leading shield. The second shield 42 is, for example, a trailing shield. The third shield 43 is at least a part of a side shield. The fourth shield 44 is at least a part of a side shield.

The first shield 41 is, for example, a bottom shield. The second shield 42 is, for example, a top shield. The third shield 43 is at least a part of the side bias layer. The fourth shield 44 is at least a part of the side bias layer.

As shown in FIG. 1A, the first reproducing element 70a may further include a first insulating member 31. The first insulating member 31 includes a first insulating region 31a and a second insulating region 31b. At least a part of the first insulating region 31a is provided between a part of the first shield 41 and the third shield 43. At least a part of the second insulating region 31b is provided between another part of the first shield 41 and the fourth shield 44.

As shown in FIG. 1, the first insulating member 31 may further include a third insulating region 31c and a fourth insulating region 31d. At least a part of the third insulating region 31c is provided between the third shield 43 and a part of the second shield 42. At least a part of the fourth insulating region 31d is provided between the fourth shield 44 and another part of the second shield 42.

As shown in FIGS. 1B and 2, a direction from the first magnetic member 11 to a part of the first insulating member 31 may be along the third direction D3. A part of the first insulating member 31 may be provided between the first shield 41 and the second shield 42. A part of the first insulating member 31 may be provided between the third shield 43 and the fourth shield 44.

### Second Embodiment

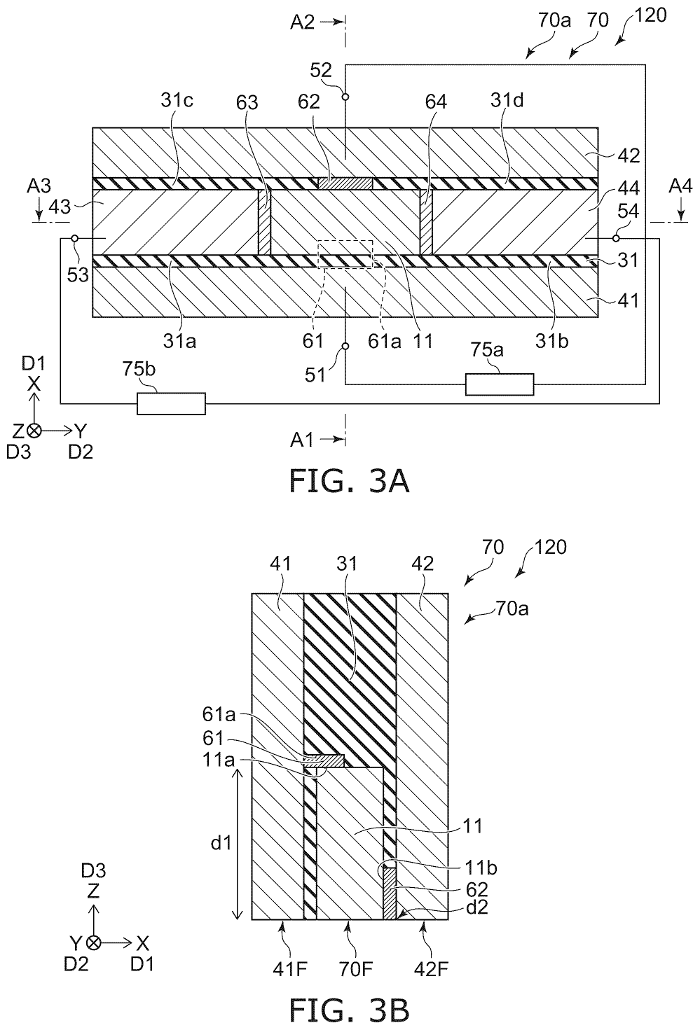

FIGS. 3A and 3B are schematic views illustrating a magnetic head according to a second embodiment.

FIG. 3A is a plan view. FIG. 3B is a cross-sectional view taken along the line A1-A2 in FIG. 3A.

As shown in FIG. 3A, in a magnetic head 120 according to the embodiment, the configuration of the second conductive member 62 differs from that in the magnetic head 110. Except for this, the configuration of the magnetic head 120 may be the same as the configuration of the magnetic head 110. For example, the configuration of the cross-section taken along the line A3-A4 in FIG. 3A may be the same as the configuration illustrated in FIG. 2.

As shown in FIG. 3A, the magnetic head 120 according to the embodiment also includes the reproducing section 70 including the first reproducing element 70a. The first reproducing element 70a includes the first shield 41, the second shield 42, the third shield 43, the fourth shield 44, the first magnetic member 11, the first conductive member 61, and the second conductive member 62.

The second direction D2 from the third shield 43 to the fourth shield 44 crosses the first direction D1 from the first shield 41 to the second shield 42. The first magnetic member 11 is provided between the first shield 41 and the second shield 42, and between the third shield 43 and the fourth shield 44.

As shown in FIG. 3B, the first conductive member 61 is electrically connected to a first portion 11a of the first magnetic member 11. The first conductive member 61 is non-magnetic. The second conductive member 62 is electrically connected to a second portion 11b of the first magnetic member 11. The second conductive member 62 is non-magnetic.

A first position of the first portion 11a in the first direction D1 is between a position of the first shield 41 in the first direction D1 and a second shield position of the second shield 42 in the first direction D1. A second position of the second portion 11b in the first direction D1 is between the first position and the second shield position. The first portion 11a and the second portion 11b are provided at different positions from each other in the first direction D1.

As shown in FIG. 3B, the first conductive member 61 includes a first conductive portion 61a. The first shield 41 includes the first end 41F corresponding to the medium facing face 70F. The second shield 42 includes the second end 42F corresponding to the medium facing face 70F. The distance between the first end 41F and the first conductive portion 61a in the third direction D3 crossing a plane including the first direction D1 and the second direction D2 is defined as the first distance d1. The distance between the second end 42F and the second conductive member 62 in the third direction D3 is defined as the second distance d2. The first distance d1 is longer than the second distance d2.

In the magnetic head 120, the direction connecting the first portion 11a and the second portion 11b is inclined with respect to the X-Y plane. For example, the voltage generated between the first conductive portion 61a and the second conductive member 62 corresponds to the component inclined with respect to the third direction D3 of magnetization in the first magnetic member 11. The signal obtained from these conductive members changes with higher sensitivity according to the inclined components of the magnetic fields emitted from the two recording regions of the magnetic recording medium. High sensitivity detection is possible. Higher recording density can be obtained. It is possible to provide a magnetic head with improved characteristics.

In this example, the first conductive member 61 (first conductive portion 61a) is electrically connected to the first shield 41. In this case, the first terminal 51 may be electrically connected to the first shield 41. The second terminal 52 is electrically connected to the second conductive member 62 via the second shield 42. As described below, the first conductive member 61 (first conductive portion 61a) may not be electrically connected to the first shield 41. In this case, the first terminal 51 is electrically connected to the first conductive member 61 (first conductive portion 61a).

In the magnetic head 120, the first reproducing element 70a may include the first terminal 51 electrically connected to the first conductive member 61, the second terminal 52 electrically connected to the second shield 42, the third terminal 53 electrically connected to the third shield 43, and the fourth terminal 54 electrically connected to the fourth shield 44.

The first reproducing element 70a may be configured to satisfy the first condition or the second condition. In the first condition, when a current flows between the third terminal 53 and the fourth terminal 54, a voltage between the first terminal 51 and the second terminal 52 changes in response to the magnetic field to be detected. In the second condition, when a current flows between the first terminal 51 and the second terminal 52, a voltage between the third terminal 53 and the fourth terminal 54 changes in response to the magnetic field to be detected.

As shown in FIG. 3A, in the first direction D1, the third shield 43 may be provided between a part of the first shield 41 and a part of the second shield 42. In the first direction D1, the fourth shield 44 may be provided between another part of the first shield 41 and another part of the second shield 42.

The first insulating member 31 described above may be provided in the magnetic head 120.

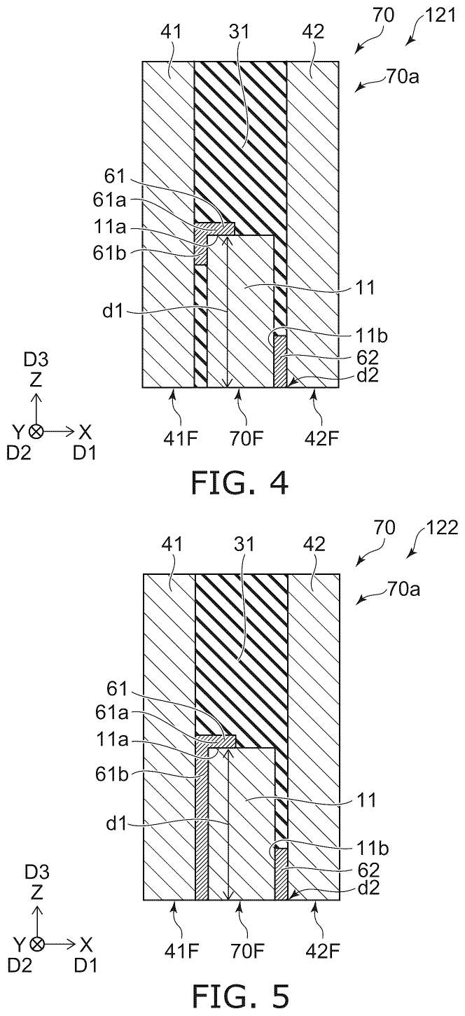

FIG. 4 is a schematic cross-sectional view illustrating a magnetic head according to the second embodiment.

FIG. 4 is a cross-sectional view corresponding to the line A1-A2 in FIG. 3A. As shown in FIG. 4, in a magnetic head 121 according to the embodiment, the first conductive member 61 further includes a second conductive portion 61b. Except for this, the configuration of the magnetic head 121 may be the same as the configuration of the magnetic head 120.

In the magnetic head 121, the first conductive member 61 includes the second conductive portion 61b in addition to the first conductive portion 61a. The second conductive portion 61b is connected to the first conductive portion 61a. The second conductive portion 61b is provided between at least a part of the first shield 41 and at least a part of the first magnetic member 11 in the first direction D1. In the magnetic head 121 as well, the signal generated between the first conductive member 61 and the second conductive member 62 changes with higher sensitivity in response to the inclined components of the magnetic field emitted from the two recording regions of the magnetic recording medium. The inclined components of magnetization can be detected with high sensitivity. High sensitivity detection is possible.

FIG. 5 is a schematic cross-sectional view illustrating a magnetic head according to the second embodiment.

FIG. 5 is a cross-sectional view corresponding to the line A1-A2 in FIG. 3A. As shown in FIG. 5, in a magnetic head 122 according to the embodiment, the configuration of the second conductive portion 61b differs from that in the magnetic head 121. Except for this, the configuration of the magnetic head 122 may be the same as the configuration of the magnetic head 121.

In the magnetic head 122, the second conductive portion 61b overlaps the first end 41F. The magnetic head 122 can also detect the inclined component of magnetization with high sensitivity.

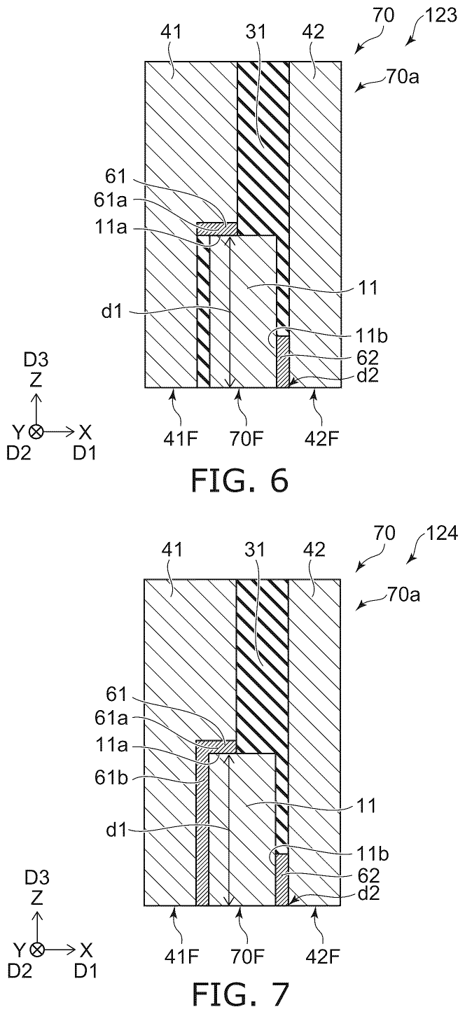

FIG. 6 is a schematic cross-sectional view illustrating a magnetic head according to the second embodiment.

FIG. 6 is a cross-sectional view corresponding to the line A1-A2 in FIG. 3A. As shown in FIG. 6, in a magnetic head 123 according to the embodiment, the configuration of the first shield 41 differs from that in the magnetic head 120. Except for this, the configuration of the magnetic head 123 may be the same as the configuration of the magnetic head 120.

In the magnetic head 123, at least a part of the first conductive portion 61a is between the first magnetic member 11 and a part of the first shield 41 in the third direction D3. The magnetic head 123 can also detect the tilted component of magnetization with high sensitivity.

FIG. 7 is a schematic cross-sectional view illustrating a magnetic head according to the second embodiment.

FIG. 7 is a cross-sectional view corresponding to the line A1-A2 in FIG. 3A. As shown in FIG. 7, in a magnetic head 124 according to the embodiment, the configurations of the first shield 41 and second conductive portion 61b differ from those in the magnetic head 121. Except for this, the configuration of the magnetic head 124 may be the same as the configuration of the magnetic head 121.

In the magnetic head 124, at least a part of the first conductive portion 61a is between the first magnetic member 11 and a part of the first shield 41 in the third direction D3. The second conductive portion 61b is provided between at least a part of the first shield 41 and at least a part of the first magnetic member 11 in the first direction D1. The magnetic head 124 can also detect the tilted component of magnetization with high sensitivity.

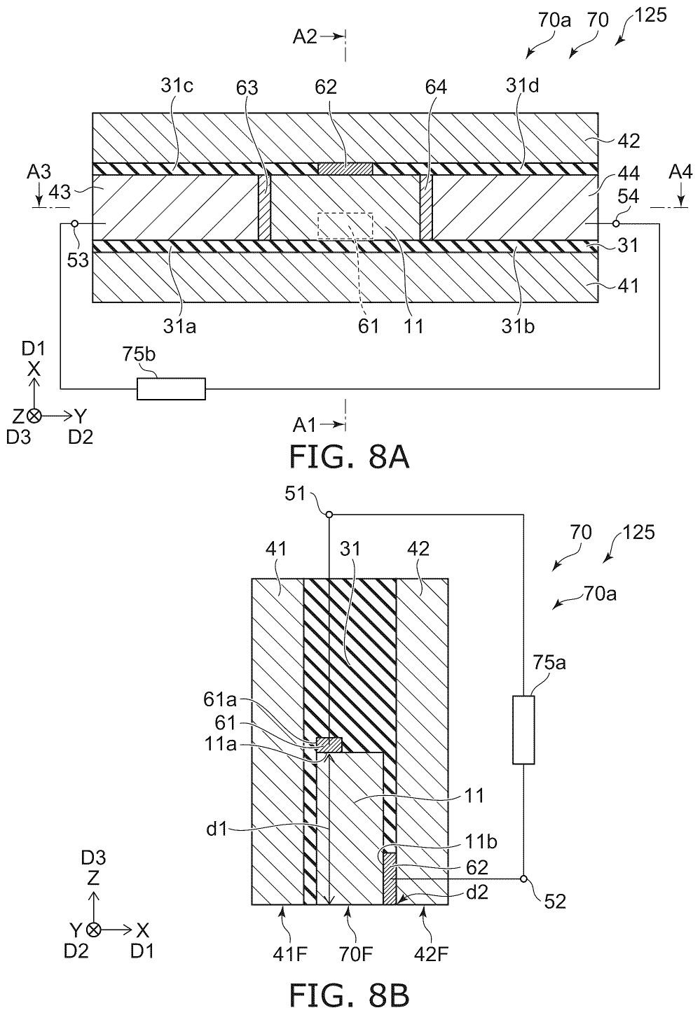

FIGS. 8A and 8B are schematic views illustrating a magnetic head according to the second embodiment.

FIG. 8A is a plan view. FIG. 8B is a cross-sectional view taken along the line A1-A2 in FIG. 8A.

As shown in FIG. 8A, in a magnetic head 125 according to the embodiment, the configuration of the first conductive member 61 differs from that in magnetic head 110. Except for this, the configuration of magnetic head 125 may be the same as the configuration of magnetic head 110. For example, the configuration of the cross-section taken along the line A3-A4 in FIG. 8A may be the same as the configuration illustrated in FIG. 2.

In the magnetic head 125, the first conductive member 61 (first conductive portion 61a) is not electrically connected to the first shield 41. The first terminal 51 is electrically connected to the first conductive member 61 (first conductive portion 61a). The second terminal 52 is electrically connected to the second shield 42. The magnetic head 125 can also detect the tilted component of magnetization with high sensitivity.

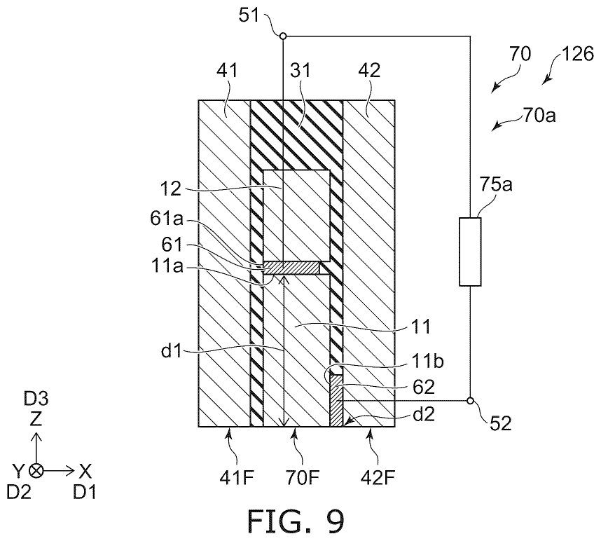

FIG. 9 is a schematic cross-sectional view illustrating a magnetic head according to the second embodiment.

As shown in FIG. 9, in a magnetic head 126 according to the embodiment, the first reproducing element 70a includes a second magnetic member 12. Except for this, the configuration of magnetic head 126 may be the same as the configuration of magnetic head 125.

In the magnetic head 126, the first reproducing element 70a further includes the second magnetic member 12 in addition to the first magnetic member 11. A direction from the first magnetic member 11 to the second magnetic member 12 is along the third direction D3. In the third direction D3, the first conductive member 61 (first conductive portion 61a) may be provided between the first magnetic member 11 and the second magnetic member 12.

The second magnetic member 12 may include, for example, IrMn. The magnetization of the first magnetic member 11 is appropriately controlled by the second magnetic member 12. For example, the magnetization of the first magnetic member 11 includes a component along the third direction D3. For example, higher sensitivity is obtained. Higher recording density is obtained.

### Third Embodiment

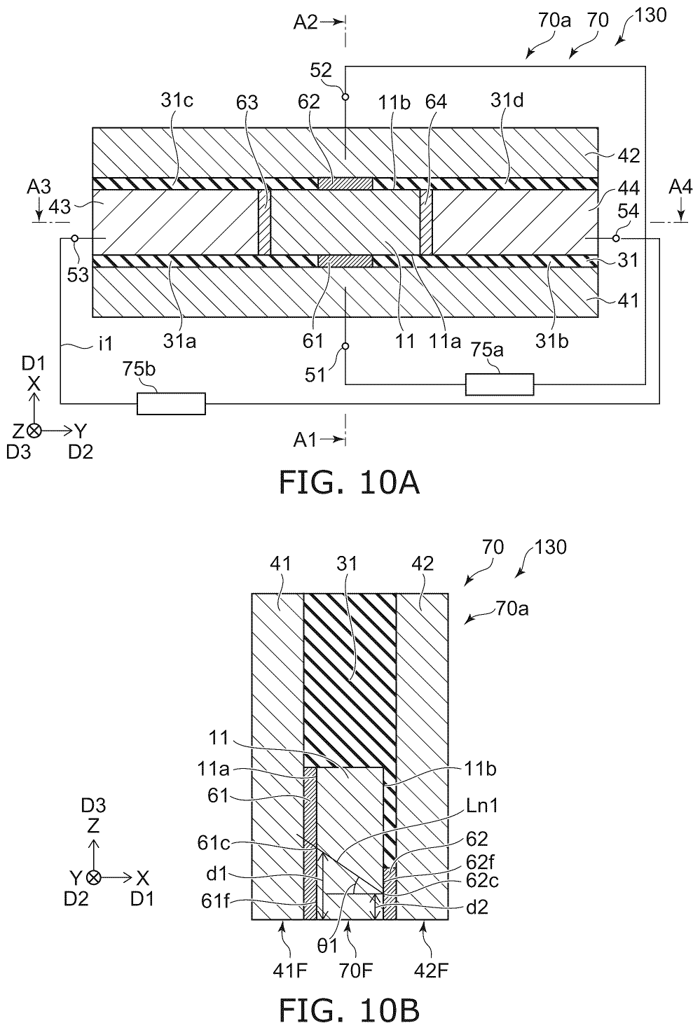

FIGS. 10A and 10B are schematic views illustrating a magnetic head according to a third embodiment.

FIG. 10A is a plan view. FIG. 10B is a cross-sectional view taken along the line A1-A2 in FIG. 10A. As shown in FIG. 10A, in a magnetic head 130 according to the embodiment, the configuration of the conductive member is different from that in magnetic head 110. Except for this, the configuration of magnetic head 130 may be the same as the configuration of magnetic head 110. For example, the configuration of the cross-section taken along the line A3-A4 in FIG. 10A may be the same as the configuration illustrated in FIG. 2.

The magnetic head 130 also includes the reproducing section 70 including the first reproducing element 70a. The first reproducing element 70a includes the first shield 41, the second shield 42, the third shield 43, the fourth shield 44, the first magnetic member 11, the first conductive member 61, and the second conductive member 62.

The second direction D2 from the third shield 43 to the fourth shield 44 crosses the first direction D1 from the first shield 41 to the second shield 42. The first magnetic member 11 is provided between the first shield 41 and the second shield 42, and between the third shield 43 and the fourth shield 44. The first conductive member 61 is provided between the first magnetic member 11 and the first shield 41, and is non-magnetic. The second conductive member 62 is provided between the first magnetic member 11 and the second shield 42, and is non-magnetic.

The first conductive member 61 includes a first face 61f facing the first magnetic member 11. The second conductive member 62 includes a second face 62f facing the first magnetic member 11. The first face 61f includes a first center 61c in the third direction D3 crossing a plane including the first direction D1 and the second direction D2. The second face 62f includes a second center 62c in the third direction D3.

The first shield 41 includes the first end 41F corresponding to the medium facing face 70F. The second shield 42 includes the second end 42F corresponding to the medium facing face 70F. The first distance d1 in the third direction D3 between the first end 41F and the first center 61c is longer than the second distance d2 in the third direction D3 between the second end 42F and the second center 62c.

A first straight line Ln1 passing through the first center 61c and the second center 62c is inclined with respect to the X-Y plane. With this configuration, the signal generated between the first conductive member 61 and the second conductive member 62 changes with higher sensitivity according to the inclined components of the magnetic field emitted from the two recording regions of the magnetic recording medium.

In the embodiment, a first angle θ1 between the first straight line Ln1 and the first direction D1 is not less than 15 degrees and not more than 80 degrees. By the first straight line Ln1 being clearly inclined, the inclined component of the magnetic field can be effectively detected. The first angle θ1 may be not less than 25 degrees and not more than 80 degrees. The first angle θ1 may be not less than 35 degrees and not more than 80 degrees.

As shown in FIG. 10B, by the position of the first center 61c in the third direction D3 being higher than the position of the second center 62c in the third direction D3, the effective electric field generated between the first face 61f and the second face 62f is tilted with respect to the first direction D1. As a result, the signal generated between the first conductive member 61 and the second conductive member 62 changes with higher sensitivity in response to the tilted components of the magnetic fields emitted from the two recording regions of the magnetic recording medium.

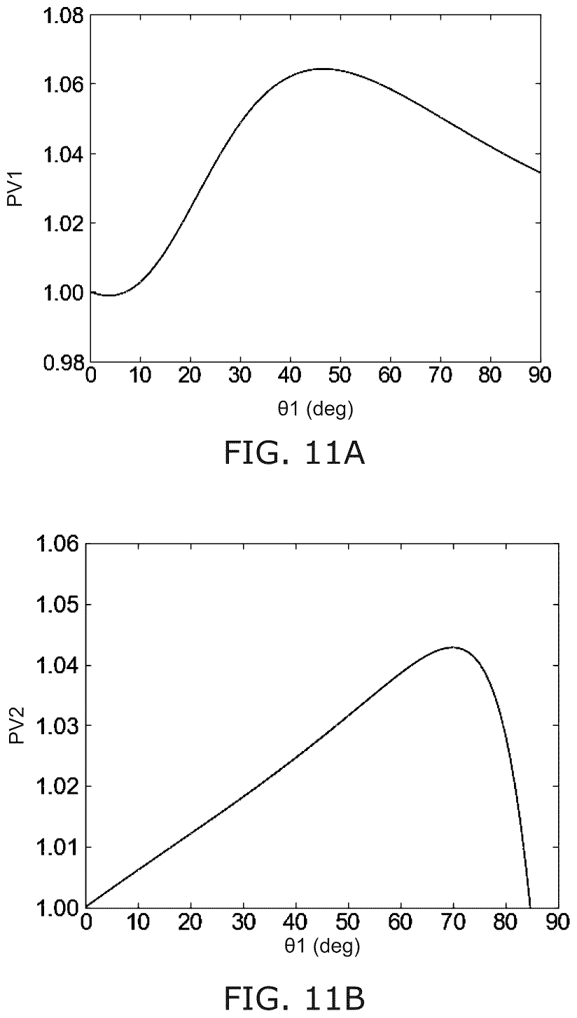

FIGS. 11A and 11B are graphs illustrating the characteristics of a magnetic head.

These figures illustrate the simulation results of the reproduction characteristics when the first angle θ1 is changed. The horizontal axis of these figures is the first angle θ1. The vertical axis of FIG. 11A is a first evaluation parameter PV1. The first evaluation parameter PV1 corresponds to the degree of noise in the reproduction signal over a relatively short period (in this example, a period of 2T). It is preferable that the first evaluation parameter PV1 is large. When the first evaluation parameter PV1 is large, the noise is small.

As shown in FIG. 11A, when the first angle θ1 is 15 degrees or more, a large first evaluation parameter PV1 is obtained. When the first angle θ1 is 25 degrees or more, the first evaluation parameter PV1 being further large is obtained. The change in the first evaluation parameter PV1 when the first angle θ1 is 15 degrees or more is critical.

The vertical axis in FIG. 11B is a second evaluation parameter PV2. The second evaluation parameter PV2 corresponds to the degree of noise in the reproduced signal over a relatively long period (in this example, a period of 6T). It is preferable that the second evaluation parameter PV2 is large. When the second evaluation parameter PV2 is large, the noise is small.

As shown in FIG. 11B, when the first angle θ1 exceeds 80 degrees, the second evaluation parameter PV2 decreases sharply. It is preferable that the first angle θ1 is 80 degrees or less. When the first angle θ1 is 35 degrees or more, a sufficiently large second evaluation parameter PV2 is obtained.

From the results of FIGS. 11A and 11B, it is preferable that the first angle θ1 is not less than 15 degrees and not more than 80 degrees. It is further preferable that the first angle θ1 is not less than 35 degrees and not more than 80 degrees.

For example, the thickness of the second conductive member 62 along the first direction D1 may be thinner than the thickness of the first conductive member 61 along the first direction. The resistance of the second conductive member 62 along the first direction D1 becomes lower. For example, it becomes easier to detect signals passing through the second conductive member 62. It becomes easier to detect signals generated between the first conductive member 61 and the second conductive member 62.

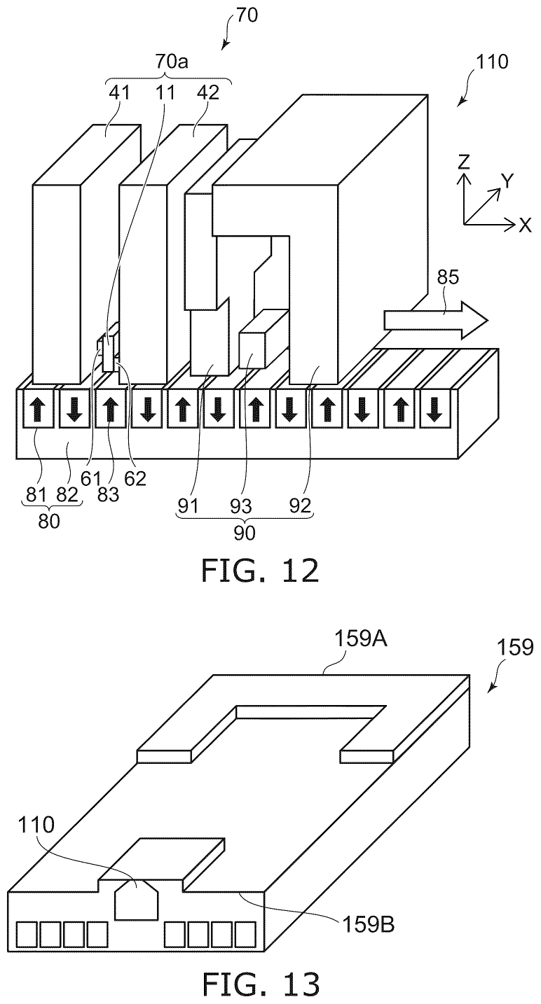

FIG. 12 is a schematic perspective view illustrating the magnetic head and the magnetic recording device according to the embodiment.

As shown in FIG. 12, the magnetic head (e.g., magnetic head 110) according to the embodiment includes the reproducing section 70. The reproducing section 70 includes the first reproducing element 70a. The reproducing section 70 may further include other reproducing elements. The magnetic head 110 is used together with a magnetic recording medium 80. The magnetic head 110 may include a recording section 90. Information is recorded on the magnetic recording medium 80 by the recording section 90 of the magnetic head 110. The information recorded on the magnetic recording medium 80 is reproduced by the reproducing section 70.

The magnetic recording medium 80 includes, for example, a medium substrate 82 and a magnetic recording layer 81 provided on the medium substrate 82. The magnetization 83 of the magnetic recording layer 81 is controlled by the recording section 90. The recording section 90 includes, for example, a first magnetic pole 91 and a second magnetic pole 92. The first magnetic pole 91 is, for example, a main magnetic pole. The second magnetic pole 92 is, for example, a trailing shield. The recording section 90 may include a recording section element 93. The recording section element 93 may include a magnetic field control element or a high-frequency oscillation element. The recording section element 93 may be omitted.

The first reproducing element 70a of the reproducing section 70 includes, for example, the first shield 41, the second shield 42, and the first magnetic member 11. In FIG. 12, the third shield 43 and the fourth shield 44 are omitted. The reproducing section 70 can output a signal corresponding to the magnetization 83 of the magnetic recording layer 81.

As shown in FIG. 12, the magnetic recording medium 80 moves relative to the magnetic head 110 in a medium movement direction 85. The magnetic head 110 controls information corresponding to the magnetization 83 of the magnetic recording layer 81 at desired position. The magnetic head 110 reproduces information corresponding to the magnetization 83 of the magnetic recording layer 81 at desired position.

For example, the medium movement direction 85 is the direction from the first shield 41 to the second shield 42. For example, the magnetic recording medium 80 includes one recording region (first region). After the first region faces the first shield 41, the first region faces the second shield 42.

In the embodiment, the second shield 42 is between the first magnetic member 11 and the recording section 90. For example, the second conductive member 62 is between the first magnetic member 11 and the recording section 90.

FIG. 13 is a schematic perspective view illustrating a part of the magnetic recording device according to the embodiment.

FIG. 13 illustrates a head slider.

The magnetic head 110 is provided on the head slider 159. The head slider 159 includes, for example, Al₂O₃/TiC or the like. The head slider 159 moves relative to the magnetic recording medium while floating or in contact with the magnetic recording medium.

The head slider 159 includes, for example, an air inflow side 159A and an air outflow side 159B. The magnetic head 110 is arranged on the side surface of the air outflow side 159B of the head slider 159 or the like. As a result, the magnetic head 110 moves relative to the magnetic recording medium while flying above or in contact with the magnetic recording medium.

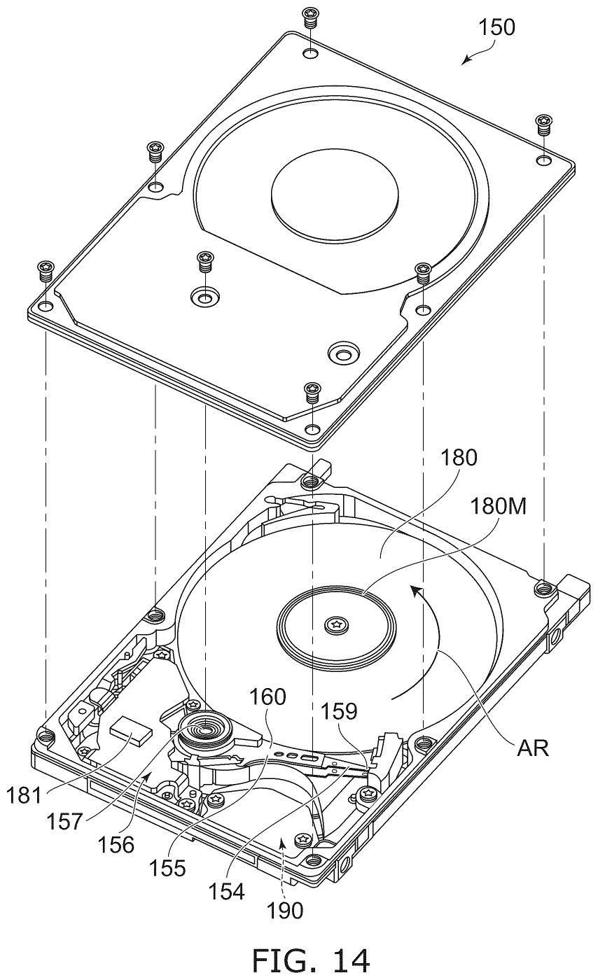

FIG. 14 is a schematic perspective view illustrating the magnetic recording device according to the embodiment.

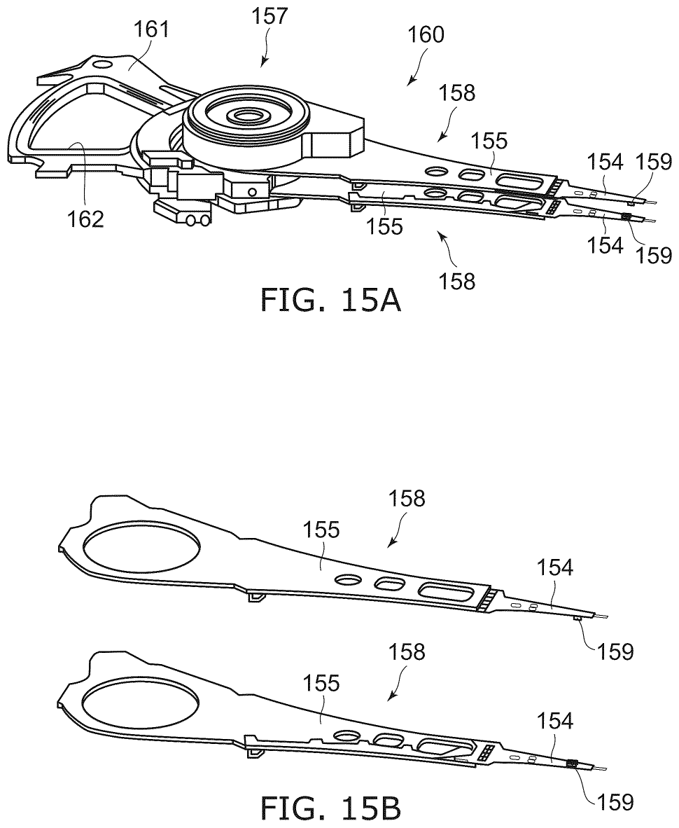

FIGS. 15A and 15B are schematic perspective views illustrating a part of the magnetic recording device according to the embodiment.

As shown in FIG. 14, in a magnetic recording device 150 according to the embodiment, a rotary actuator is used. The recording medium disk 180 is connected to a spindle motor 180M. The recording medium disk 180 is rotated in a direction of arrow AR by the spindle motor 180M. The spindle motor 180M is responsive to control signals from the drive device controller. The magnetic recording device 150 according to the embodiment may include the multiple recording medium disks 180. The magnetic recording device 150 may include a recording medium 181. The recording medium 181 is, for example, an SSD (Solid State Drive). A non-volatile memory such as a flash memory is used for the recording medium 181, for example. For example, the magnetic recording device 150 may be a hybrid HDD (Hard Disk Drive).

The head slider 159 records and reproduces information to be recorded on the recording medium disk 180. The head slider 159 is provided at an end of a thin-film suspension 154. A magnetic head according to the embodiment is provided near the end of the head slider 159.

While the recording medium disk 180 is rotating, the pressing pressure by the suspension 154 and the floating pressure generated at the medium facing face (ABS) of the head slider 159 are balanced. The distance between the medium facing face of the head slider 159 and the surface of the recording medium disk 180 is the predetermined fly height. In the embodiment, the head slider 159 may contact the recording medium disk 180. For example, a contact sliding type may be applied.

The suspension 154 is connected to one end of an arm 155 (e.g., an actuator arm). The arm 155 includes, for example, a bobbin part or the like. The bobbin part holds a drive coil. A voice coil motor 156 is provided at the other end of the arm 155. The voice coil motor 156 is a type of linear motor. The voice coil motor 156 includes, for example, a drive coil and a magnetic circuit. The drive coil is wound on the bobbin part of the arm 155. The magnetic circuit includes permanent magnets and opposing yokes. The drive coil is provided between the permanent magnet and the opposing yoke. The suspension 154 includes one end and the other end. The magnetic head is provided at one end of the suspension 154. The arm 155 is connected to the other end of the suspension 154.

The arm 155 is held by ball bearings. Ball bearings are provided at two locations above and below a bearing part 157. The arm 155 can be rotated and slid by the voice coil motor 156. The magnetic head can move to any position on the recording medium disk 180.

FIG. 15A is an enlarged perspective view of the head stack assembly 160, illustrating the configuration of a part of the magnetic recording device.

FIG. 15B is a perspective view illustrating the magnetic head assembly (head gimbal assembly: HGA) 158 that forms part of the head stack assembly 160.

As shown in FIG. 15A, the head stack assembly 160 includes the bearing part 157, the magnetic head assembly 158 and a support frame 161. The magnetic head assembly 158 extends from the bearing part 157. The support frame 161 extends from the bearing part 157. A direction in which the support frame 161 extends is opposite to a direction in which the magnetic head assembly 158 extends. The support frame 161 supports a coil 162 of the voice coil motor 156.

As shown in FIG. 15B, the magnetic head assembly 158 includes the arm 155 extending from the bearing part 157 and the suspension 154 extending from the arm 155.

The head slider 159 is provided at the end of the suspension 154. The head slider 159 is provided with the magnetic head according to the embodiment.

The magnetic head assembly 158 (head gimbal assembly) according to the embodiment includes the magnetic head according to the embodiment, the head slider 159 provided with the magnetic head, the suspension 154 and the arm 155. The head slider 159 is provided at one end of the suspension 154. The arm 155 is connected to the other end of the suspension 154.

The suspension 154 may include, for example, a wiring (not shown) for recording and reproducing signals. The suspension 154 may include, for example, a heater wiring (not shown) for adjusting the fly height. The suspension 154 may include a wiring (not shown) for, for example, an oscillator element or the like. These wires may be electrically connected to multiple electrodes provided on the magnetic head.

A signal processor 190 is provided in the magnetic recording device 150. The signal processor 190 uses a magnetic head to record and reproduce signals on a magnetic recording medium. Input/output lines of the signal processor 190 are connected to, for example, electrode pads of the magnetic head assembly 158 and electrically connected to the magnetic head.

The magnetic recording device 150 according to the embodiment includes the magnetic recording medium, the magnetic head according to the embodiment, a movable part, a position controller, and a signal processor. The movable part separates the magnetic recording medium from the magnetic head or makes them relatively movable while they are in contact with each other. The position controller aligns the magnetic head with a predetermined recording position on the magnetic recording medium. The signal processor records and reproduces signals on the magnetic recording medium using the magnetic head.

For example, the recording medium disk 180 is used as the above magnetic recording medium. The movable part includes, for example, the head slider 159. The position controller described above includes, for example, the magnetic head assembly 158.

The embodiments may include the following Technical proposals:

### (Technical Proposal 1)

A magnetic head, comprising:
a reproducing section including a first reproducing element, the first reproducing element including:
   a first shield;
   a second shield;
   a third shield;
   a fourth shield, a second direction from the third shield to
   the fourth shield crossing a first direction from the first shield to the second shield;
   a first magnetic member provided between the first shield and the second shield, and between the third shield and the fourth shield;
   a first conductive member provided between the first shield and the first magnetic member, the first conductive member being non-magnetic; and
   a second conductive member provided between the first magnetic member and the second shield, the second conductive member being non-magnetic,
   the first shield including a first end corresponding to a medium facing face,
   the second shield including a second end corresponding to the medium facing face, and
   a first distance between the first end and the first conductive member in a third direction crossing a plane including the first direction and the second direction being longer than a second distance between the second end and the second conductive member in the third direction.

### (Technical Proposal 2)

The magnetic head according to Technical proposal 1, wherein
the second conductive member does not overlap the first conductive member in the first direction.

### (Technical Proposal 3)

The magnetic head according to Technical proposal 1 or 2, wherein
in the first direction, the third shield is between a part of the first shield and a part of the second shield, and
in the first direction, the fourth shield is between another part of the first shield and another part of the second shield.

### (Technical Proposal 4)

The magnetic head according to any one of Technical proposals 1-3, wherein
the first conductive member is in contact with the first magnetic member, and
the second conductive member is in contact with the first magnetic member.

### (Technical Proposal 5)

The magnetic head according to any one of Technical proposals 1-4, wherein
the reproducing section further includes:
a first terminal electrically connected to the first shield;
a second terminal electrically connected to the second shield;
a third terminal electrically connected to the third shield; and
a fourth terminal electrically connected to the fourth shield.

### (Technical Proposal 6)

The magnetic head according to Technical proposal 5, wherein
the first reproducing element is configured to satisfy a first condition or a second condition,
in the first condition, when a current flows between the third terminal and the fourth terminal, a voltage between the first terminal and the second terminal changes according to a magnetic field to be detected, and
in the second condition, when a current flows between the first terminal and the second terminal, a voltage between the third terminal and the fourth terminal changes in response to the magnetic field to be detected.

### (Technical Proposal 7)

A magnetic head, comprising:
a reproducing section including a first reproducing element, the first reproducing element including:
   a first shield;
   a second shield;
   a third shield;
   a fourth shield, a second direction from the third shield to the fourth shield crossing a first direction from the first shield to the second shield;
   a first magnetic member provided between the first shield and the second shield, and between the third shield and the fourth shield;
   a first conductive member electrically connected to a first portion of the first magnetic member, the first conductive member being non-magnetic; and
   a second conductive member electrically connected to a second portion of the first magnetic member, the second conductive member being non-magnetic,
   a first position of the first portion in the first direction being between a position of the first shield in the first direction and a second shield position of the second shield in the first direction,
   a second position of the second portion in the first direction being between the first position and the second shield position,
   the first conductive member including a first conductive portion,
   the first shield including a first end corresponding to a medium facing face,
   the second shield including a second end corresponding to the medium facing face,
   a first distance between the first end and the first conductive portion in a third direction crossing a plane including the first direction and the second direction being longer than a second distance between the second end and the second conductive member in the third direction.

### (Technical Proposal 8)

The magnetic head according to Technical proposal 7, wherein
the first conductive member includes a second conductive portion,
the second conductive portion is connected to the first conductive portion,
the second conductive portion is provided between at least a part of the first shield and at least a part of the first magnetic member in the first direction.

### (Technical Proposal 9)

The magnetic head according to Technical proposal 7 or 8, wherein
in the first direction, the third shield is between a part of the first shield and a part of the second shield, and
in the first direction, the fourth shield is between another part of the first shield and another part of the second shield.

### (Technical Proposal 10)

The magnetic head according to any one of Technical proposals 7-9, wherein
the first reproducing element further includes:
a first terminal electrically connected to the first conductive portion;
a second terminal electrically connected to the second shield;
a third terminal electrically connected to the third shield; and
a fourth terminal electrically connected to the fourth shield.

### (Technical Proposal 11)

The magnetic head according to Technical proposal 10, wherein
the first reproducing element is configured to satisfy a first condition or a second condition,
in the first condition, when a current flows between the third terminal and the fourth terminal, a voltage between the first terminal and the second terminal changes according to a magnetic field to be detected, and
in the second condition, when a current flows between the first terminal and the second terminal, a voltage between the third terminal and the fourth terminal changes in response to the magnetic field to be detected.

### (Technical Proposal 12)

The magnetic head according to any one of Technical proposals 7-11, wherein
at least a part of the first conductive portion is between the first magnetic member and a part of the first shield in the third direction.

### (Technical Proposal 13)

The magnetic head according to any one of Technical proposals 7-12, wherein
the first reproducing element further includes a second magnetic member, and
a direction from the first magnetic member to the second magnetic member is along the third direction.

### (Technical Proposal 14)

A magnetic head, comprising:
a reproducing section including a first reproducing element, the first reproducing element including:
   a first shield;
   a second shield;
   a third shield;
   a fourth shield, a second direction from the third shield to the fourth shield crossing a first direction from the first shield to the second shield;
   a first magnetic member provided between the first shield and the second shield, and between the third shield and the fourth shield;
   a first conductive member provided between the first magnetic member and the first shield, the first conductive member being non-magnetic; and
   a second conductive member provided between the first magnetic member and the second shield, the second conductive member being non-magnetic,
   the first conductive member including a first face facing the first magnetic member,
   the second conductive member including a second face facing the first magnetic member,
   the first face including a first center in a third direction crossing a plane including the first direction and the second direction,
   the second face including a second center in the third direction,
   the first shield including a first end corresponding to a medium facing face,
   the second shield including a second end corresponding to the medium facing face,
   a first distance in the third direction between the first end and the first center being longer than a second distance in the third direction between the second end and the second center, and
   a first angle between a first line passing through the first center and the second center, and the first direction being not less than 15 degrees and not more than 80 degrees.

### (Technical Proposal 15)

The magnetic head according to Technical proposal 14, wherein
the first angle is not less than 35 degrees and not more than 80 degrees.

### (Technical Proposal 16)

The magnetic head according to Technical proposal 14 or 15, wherein
the first reproducing element further includes:
a first terminal electrically connected to the first shield;
a second terminal electrically connected to the second shield;
a third terminal electrically connected to the third shield; and
a fourth terminal electrically connected to the fourth shield,
   the first reproducing element being configured to satisfy a first condition or a second condition,
   in the first condition, when a current flows between the third terminal and the fourth terminal, a voltage between the first terminal and the second terminal changes according to a magnetic field to be detected, and
   in the second condition, when a current flows between the first terminal and the second terminal, a voltage between the third terminal and the fourth terminal changes according to the magnetic field to be detected.

### (Technical Proposal 17)

The magnetic head according to any one of Technical proposals 1-14, further comprising:
a recording section,
the second shield being between the first magnetic member and the recording section.

### (Technical Proposal 18)

The magnetic head according to any one of Technical proposals 1-17, wherein
the first magnetic member includes at least one selected from the group consisting of Co₂MnGa, Co₂MnAl, FePt, MnGa, Mn₃Sn, Mn₃Ge, Mn₃Ga, RuO₂, MnTe, CrSb, and Mn₅Si₃.

### (Technical Proposal 19)

A magnetic recording device, comprising:
the magnetic head according to any one of Technical proposals 1-18; and
a magnetic recording medium,
the reproducing section being configured to reproduce information recorded on the magnetic recording medium.

### (Technical Proposal 20)

The magnetic recording device according to Technical proposal 19, wherein
the magnetic recording medium includes a first region, and
after the first region faces the first shield, the first region faces the second shield.

According to the embodiment, a magnetic head and a magnetic recording device can be provided that can improve characteristics.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in magnetic heads and magnetic recording devices such as shields, magnetic layers, conductive members, terminals, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all magnetic heads and all magnetic recording devices practicable by an appropriate design modification by one skilled in the art based on the magnetic heads and the magnetic recording devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A magnetic head, comprising:
a reproducing section including a first reproducing element, the first reproducing element including:
a first shield;
a second shield;
a third shield;
a fourth shield, a second direction from the third shield to the fourth shield crossing a first direction from the first shield to the second shield;
a first magnetic member provided between the first shield and the second shield, and between the third shield and the fourth shield;
a first conductive member provided between the first shield and the first magnetic member, the first conductive member being non-magnetic; and
a second conductive member provided between the first magnetic member and the second shield, the second conductive member being non-magnetic,
the first shield including a first end corresponding to a medium facing face,
the second shield including a second end corresponding to the medium facing face, and
a first distance between the first end and the first conductive member in a third direction crossing a plane including the first direction and the second direction being longer than a second distance between the second end and the second conductive member in the third direction.

2. The magnetic head according to claim 1, wherein
the second conductive member does not overlap the first conductive member in the first direction.

3. The magnetic head according to claim 1, wherein
in the first direction, the third shield is between a part of the first shield and a part of the second shield, and
in the first direction, the fourth shield is between another part of the first shield and another part of the second shield.

4. The magnetic head according to claim 1, wherein
the first conductive member is in contact with the first magnetic member, and
the second conductive member is in contact with the first magnetic member.

5. The magnetic head according to claim 1, wherein
the reproducing section further includes:
a first terminal electrically connected to the first shield;
a second terminal electrically connected to the second shield;
a third terminal electrically connected to the third shield; and
a fourth terminal electrically connected to the fourth shield.

6. The magnetic head according to claim 5, wherein
the first reproducing element is configured to satisfy a first condition or a second condition,
in the first condition, when a current flows between the third terminal and the fourth terminal, a voltage between the first terminal and the second terminal changes according to a magnetic field to be detected, and
in the second condition, when a current flows between the first terminal and the second terminal, a voltage between the third terminal and the fourth terminal changes in response to the magnetic field to be detected.

7. A magnetic head, comprising:
a reproducing section including a first reproducing element, the first reproducing element including:
a first shield;
a second shield;
a third shield;
a fourth shield, a second direction from the third shield to the fourth shield crossing a first direction from the first shield to the second shield;
a first magnetic member provided between the first shield and the second shield, and between the third shield and the fourth shield;
a first conductive member electrically connected to a first portion of the first magnetic member, the first conductive member being non-magnetic; and
a second conductive member electrically connected to a second portion of the first magnetic member, the second conductive member being non-magnetic,
a first position of the first portion in the first direction being between a position of the first shield in the first direction and a second shield position of the second shield in the first direction,
a second position of the second portion in the first direction being between the first position and the second shield position,
the first conductive member including a first conductive portion,
the first shield including a first end corresponding to a medium facing face,
the second shield including a second end corresponding to the medium facing face,
a first distance between the first end and the first conductive portion in a third direction crossing a plane including the first direction and the second direction being longer than a second distance between the second end and the second conductive member in the third direction.

8. The magnetic head according to claim 7, wherein
the first conductive portion overlaps the first magnetic member in the third direction.

9. The magnetic head according to claim 8, wherein
the first conductive member includes a second conductive portion,
the second conductive portion is connected to the first conductive portion,
the second conductive portion is provided between at least a part of the first shield and at least a part of the first magnetic member in the first direction.

10. The magnetic head according to claim 8, wherein
in the first direction, the third shield is between a part of the first shield and a part of the second shield, and
in the first direction, the fourth shield is between another part of the first shield and another part of the second shield.

11. The magnetic head according to claim 8, wherein
the first reproducing element further includes:
a first terminal electrically connected to the first conductive portion;
a second terminal electrically connected to the second shield;
a third terminal electrically connected to the third shield; and
a fourth terminal electrically connected to the fourth shield,
the first reproducing element is configured to satisfy a first condition or a second condition,
in the first condition, when a current flows between the third terminal and the fourth terminal, a voltage between the first terminal and the second terminal changes according to a magnetic field to be detected, and
in the second condition, when a current flows between the first terminal and the second terminal, a voltage between the third terminal and the fourth terminal changes in response to the magnetic field to be detected.

12. The magnetic head according to claim 7, wherein
at least a part of the first conductive portion is between the first magnetic member and a part of the first shield in the third direction.

13. The magnetic head according to claim 7, wherein
the first reproducing element further includes a second magnetic member, and
a direction from the first magnetic member to the second magnetic member is along the third direction.

14. A magnetic head, comprising:
a reproducing section including a first reproducing element, the first reproducing element including:
a first shield;
a second shield;
a third shield;
a fourth shield, a second direction from the third shield to the fourth shield crossing a first direction from the first shield to the second shield;
a first magnetic member provided between the first shield and the second shield, and between the third shield and the fourth shield;
a first conductive member provided between the first magnetic member and the first shield, the first conductive member being non-magnetic; and
a second conductive member provided between the first magnetic member and the second shield, the second conductive member being non-magnetic,
the first conductive member including a first face facing the first magnetic member,
the second conductive member including a second face facing the first magnetic member,
the first face including a first center in a third direction crossing a plane including the first direction and the second direction,
the second face including a second center in the third direction,
the first shield including a first end corresponding to a medium facing face,
the second shield including a second end corresponding to the medium facing face,
a first distance in the third direction between the first end and the first center being longer than a second distance in the third direction between the second end and the second center, and
a first angle between a first line passing through the first center and the second center, and the first direction being not less than 15 degrees and not more than 80 degrees.

15. The magnetic head according to claim 14, wherein the first angle is not less than 35 degrees and not more than 80 degrees.

16. The magnetic head according to claim 14, wherein the first reproducing element further includes:
a first terminal electrically connected to the first shield;
a second terminal electrically connected to the second shield;
a third terminal electrically connected to the third shield; and
a fourth terminal electrically connected to the fourth shield,
the first reproducing element being configured to satisfy a first condition or a second condition,
in the first condition, when a current flows between the third terminal and the fourth terminal, a voltage between the first terminal and the second terminal changes according to a magnetic field to be detected, and
in the second condition, when a current flows between the first terminal and the second terminal, a voltage between the third terminal and the fourth terminal changes according to the magnetic field to be detected.

17. The magnetic head according to claim 1, further comprising:
a recording section,
the second shield being between the first magnetic member and the recording section.

18. The magnetic head according to claim 1, wherein the first magnetic member includes at least one selected from the group consisting of Co₂MnGa, Co₂MnAl, FePt, MnGa, Mn₃Sn, Mn₃Ge, Mn₃Ga, RuO₂, MnTe, CrSb, and Mn₅Si₃.

19. A magnetic recording device, comprising:
the magnetic head according to claim 1; and
a magnetic recording medium,
the reproducing section being configured to reproduce information recorded on the magnetic recording medium.

20. The magnetic recording device according to claim 19, wherein
the magnetic recording medium includes a first region, and
after the first region faces the first shield, the first region faces the second shield.
